(19) United States
(12) Patent Application Publication
(10) Pub. No.: US 2012/0103277 A1
(43) Pub. Date: May 3, 2012

(54) Proximity device for a child

(76) Inventor: Sunny Klein, Jordan, MN (US)

(21) Appl. No.: 13/285,013

(22) Filed: Oct. 31, 2011

Related U.S. Application Data
(60) Provisional application No. 61/408,652, filed on Oct. 31, 2010.

(51) Int. Cl. A01K 27/00; A62B 35/00

(52) U.S. Cl. 119/770

(57) ABSTRACT

A proximity device for a child includes a hub configured for engagement with a caretaker, an extension element connected to the hub at a first end and extending to a second end, and an attraction element connected to the second end of the extension element, the attraction element being configured for engagement with a child and including an attraction feature desirable by a child, wherein, when the hub is engaged with a caretaker and the attraction element is engaged with a child, the device controls the proximity of the child to the adult.

### CROSS REFERENCE TO RELATED APPLICATIONS

This application claims priority to U.S. Provisional Patent Application No. 61/408,652 filed on Oct. 31, 2010 entitled; Proximity Device for a Child, the content of which is hereby incorporated by reference herein, in its entirety.

### FIELD OF THE INVENTION

The present disclosure relates to child control. More particularly, the present disclosure relates to adult control of a child's location relative to the adult. Still more particularly, the present disclosure relates to a device for controlling the proximity of a child relative to the adult while the adult and child are each on foot.

### BACKGROUND

As children are raised and parents or other guardians take them places, the devices and systems used to transport the children follow a relatively common progression. When the child is in infant stages, the caretaker may rely on an infant car seat that is removable from a vehicle and may carry the car seat with the infant inside or rest the car seat on a stroller or shopping cart. In other situations, the caretaker may instead carry the child against the body with a fabric type carrier. As the child becomes too big for an infant car seat and too big for an against-the-body type carrier, it is common for caretakers to remove the child from a car seat when a destination is reached and place the child in a stroller or shopping cart. Common destinations may include stores, malls, parks, museums, plazas, and zoos. The caretaker can navigate the distance from a parking location into the destination and throughout the destination with the child in the stroller.

At some point in the above described progression, the stroller option becomes less and less feasible. This may be because the child is getting too big for the stroller or is not interested in being in the stroller anymore. In other cases, the stroller option may be difficult due to multiple children. That is, a parent may not be able to push more than one stroller or may not have access to a multiple child stroller. In other instances, the destination to be navigated may not be conducive to use of a large cumbersome multiple child stroller or the stop may not be worth the time and effort to set up the stroller. In other cases, it may be time for the child to begin to learn to stay close without being contained by a stroller. When the child or children are guided into a destination and are not in a stroller, the ability to maintain safe control over the child or children can be difficult.

### SUMMARY

In one embodiment, a proximity device for a child may include a hub configured for engagement with a caretaker, an extension element connected to the hub at a first end and extending to a second end, and an attraction element connected to the second end of the extension element. The attraction element may be configured for engagement with a child and may also include an attraction feature desirable by a child. The hub may be engaged with a caretaker and the attraction element may be engaged with a child such that the device controls the proximity of the child to the adult.

In another embodiment, an interchangeable attraction element for the proximity device described above may include an attraction feature desirable by a child and the attraction element may be configured for engagement with the child. When the hub is engaged with a caretaker and the attraction element is engaged with a child, the device may control the proximity of the child to the adult.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 shows a parent using a proximity device according to one embodiment.

FIG. 2 shows the proximity device of FIG. 1.

FIGS. 3A and 3B show close-up views of a hub of the proximity device of FIG. 1.

FIG. 4 shows a proximity device according to another embodiment.

FIGS. 5A and 5B show close-up views of a connection feature for use with an embodiment of the proximity device.

FIG. 6 shows a close-up view of an attraction element of the proximity device of FIG. 1

FIG. 7 shows a close-up view of the hub of FIG. 1 including a retractability feature.

FIGS. 8A and 8B show extension elements of the proximity device of FIG. 1 with retractability incorporated therein.

FIGS. 9A and 9B show embodiments of a retractability feature incorporated into an attraction element of the proximity device of FIG. 1.

FIG. 10 shows a close-up view of a non-tangle feature incorporated into the hub of the proximity device of FIG. 1.

FIGS. 11A and 11B show embodiments of a proximity device with proximity sensors incorporated therein.

FIG. 12 shows a proximity device according to another embodiment.

### DESCRIPTION

The present disclosure relates to a proximity device for use in maintaining control over a child or multiple children. The device may include a hub or handle for gripping by or engagement with a parent and one or more extension elements leading to an attraction element for gripping by or engagement with a child. The proximity device may thus limit the distance that a child can stray from an adult without letting go of or disengaging with the attraction element. The device may be used by caretakers to maintain safe control over children when navigating stores or other locations. The device may be particularly useful in situations where multiple children are involved and a multiple child stroller is not available or desired. The device may also be useful when a stroller is simply not conducive for a particular situation, for example, where a stop at a location is short or the destination is difficult to navigate with a stroller.

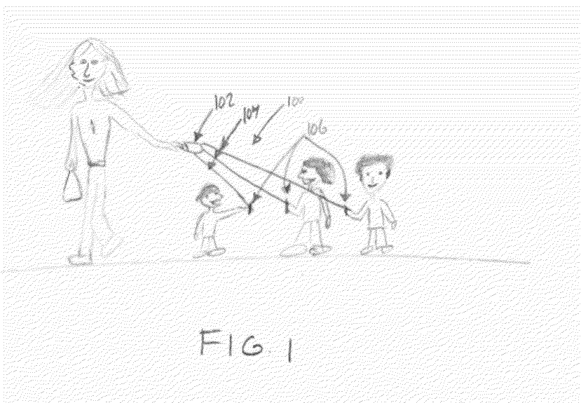

Referring now to FIG. 1, a proximity device 100 is shown in use by a caretaker. As can be seen from the figure, the caretaker is holding a handle 102 on one end of the device and three children are holding onto attraction elements 106 connected to ends of extension elements 104 extending from the handle 102. As can be seen, the device 100 may limit the distance that any particular child can stray from the caretaker without letting go of or disengaging with their respective attraction element 106.

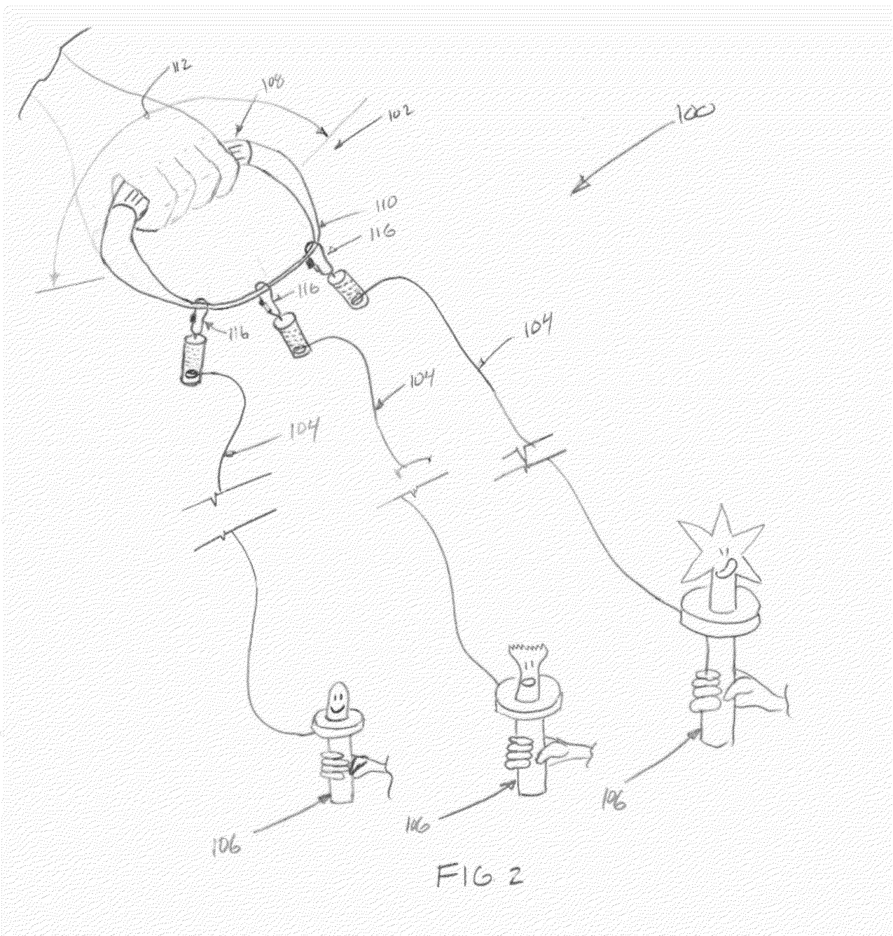

Referring now to FIG. 2, a close-up view of a proximity device 100 is shown. As can be seen from the figure, the device 100 may include a handle or hub 102, an extension element 104, and an attraction element 106. The handle or hub 102 may be held or gripped by a caretaker. The extension element 104 may be connected to the handle or hub 102 at one end and extend away from the handle or hub 102. At the other end, the extension element 104 may be connected to the attraction element 106. Accordingly, the distance between the handle or hub 102 and the attraction element 106 may be limited by the extension element 104.

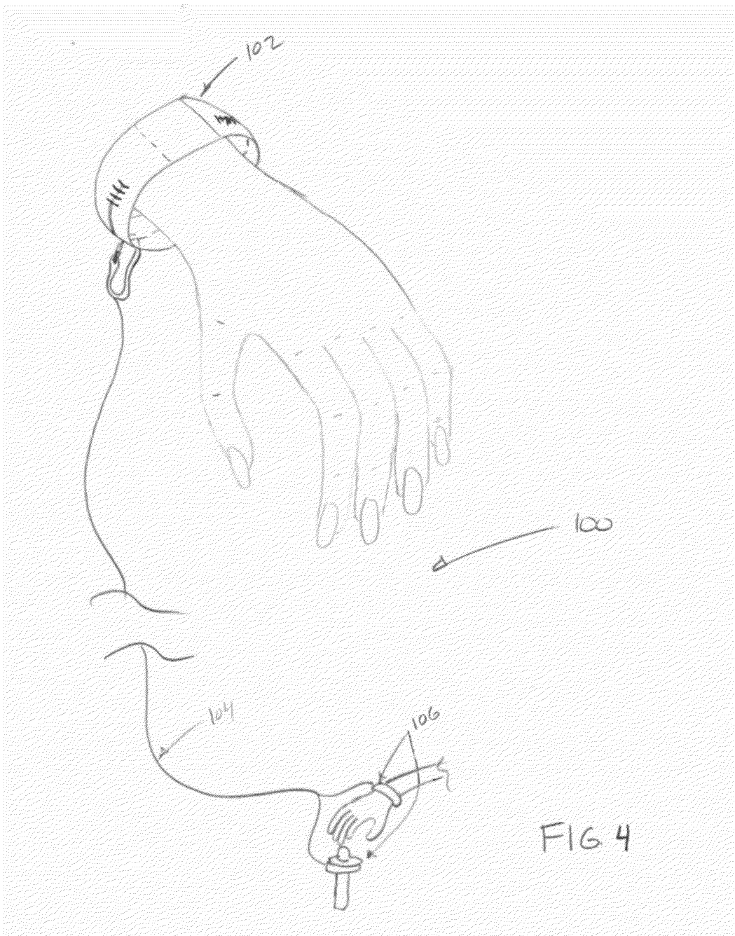

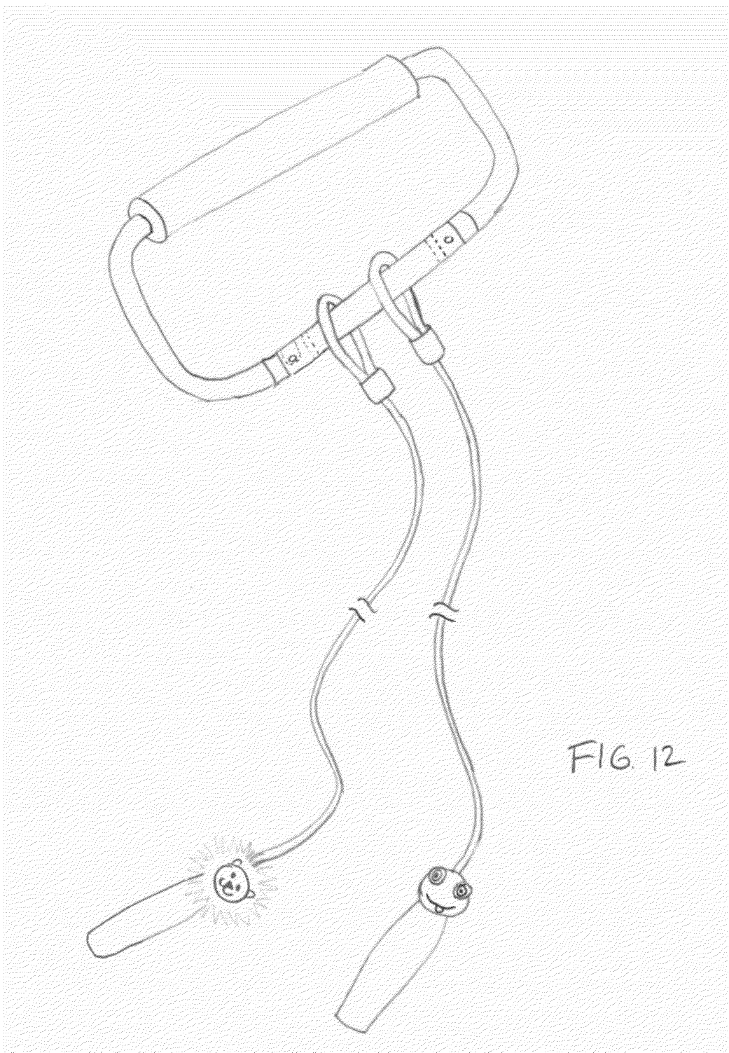

The handle or hub 102 may now be described in more detail. The handle or hub 102 may be configured for engagement with a caretaker and for connection of one or more extension elements 104. In some embodiments, the hub 102 may be configured for securing to the caretaker and may be in the form of a strap, bracelet, or other hands free hub 102, as shown in FIG. 4. In these embodiments, the hub 102 may be positioned around the wrist, waist, leg, or other portion of the caretaker's body. The hub 102 may be stretchable for placement around a portion of the body or it may be adapted for wrapping and securing thereon. Where the hub 102 is wrapped around a portion of the caretaker's body it may be secured in place with buttons, hook and loop, or other securing means. In other embodiments, and as shown in FIG. 2, the handle or hub 102 may be configured to be held by a caretaker. For example, the handle or hub 102 may be a rod, stick, baton, ring, D-ring, U-shaped ring, or other shaped element. In one embodiment, as shown in FIG. 12, the handle or hub may be in the form of a carabiner clip, large carabiner clip, or jumbo carabiner clip, for example. In these embodiments, the handle or hub 102 may include a gripping portion 108 and an attachment portion 110. The caretaker may grip the gripping portion 108 and the extension elements 104 may extend from the attachment portion 110.

The gripping portion 108 may be adapted for holding by a human hand may be any shape grippable by a hand. For example, the gripping portion 108 may be in the form of an elongate rung like a rod, stick, or baton. In other embodiments, the gripping portion 108 may be an oblong shape configured for placement in the palm of the hand with an edge adapted for receiving fingers wrapped there around. For example, an element similar to that found of a climbing wall or other cup-shaped element may be provided. Other elements grippable by the human hand may be provided.

In the embodiment shown, the gripping portion 108 may be generally elongate and cylindrically shaped. Other cross-sections such as square, rectangular, triangular, or flat, for example, may be provided. The gripping portion 108 may have a textured surface for enhancing the ability of the user to hold and resist slippage of the handle 102 relative to the user's hand. The gripping portion 108 may also include finger grooves or recesses similar to some bicycle handle grips, for example. The gripping portion 108 may also include a sleeved grip such as a rubber or other synthetic material sleeve for enhancing the grip of the user. Other material sleeves may be used for enhanced touch and feel of the grip.

The gripping portion 108 may have a cross-sectional dimension, such as a diameter or width, ranging from approximately 1/64″ to approximately 6″ In other embodiments, the gripping portion 108 may have a cross-sectional dimension ranging from approximately ½ to approximately 4″. In other embodiments, the cross-sectional dimension may be approximately 1″. Other cross-sectional dimensions outside the ranges mentioned may also be provided and may depend on the cross-sectional shape provided. For example, where a strap-like gripping portion 108 is provided, the cross-sectional dimension, for example the thickness, may be relatively small or thin (e.g., approximately 1/64″), while the width may be relatively large (e.g., approximately 1-2″).

The gripping portion 108 may be relatively straight, arcuate, or may include one or more angular turns. The gripping portion 108 may have a length 112 ranging from approximately 1″ to approximately 24″. In other embodiments, the length 112 may range from approximately 2″ to approximately 12″. In still other embodiments, the length 112 may range from approximately 3″ to approximately 6″. Other lengths 112 may be provided outside the ranges mentioned.

In the case of a carabiner handle 102 as shown in FIG. 12, for example, the gripping portion 108 may include an elongate side of the carabiner clip opposite the clip side. In some embodiments, as shown, the elongate side may include a sleeved rubber, foam, foam rubber, or other sleeved grip.

The attachment portion 110 of the handle 102 may be incorporated into the gripping portion 108 or it may extend from and be securely connected thereto. In some embodiments, the attachment portion 110 may rigidly extend from the gripping portion 108 by being a relatively rigid rod, shaft, horn, hook, loop, or other shape extending from the gripping portion 108 and may be monolithic therewith. For example, where the handle 102 is a rod, stick, or baton type element, a portion of the length of the baton may be the gripping portion 108 and the attachment portion 110 may include another or remaining portion of the length. In other rigid type embodiments where, for example, the handle 102 is ring-shaped, as shown, D-shaped, U-shaped, or some other curved shape, the attachment portion 110 may extend from the gripping portion 108 and turn or otherwise redirect relative to the gripping portion 108. In other embodiments, the attachment portion 110 may extend flexibly from the gripping portion 108 and may be in the form of a strap, string, rope, or other flexible element. Where the gripping portion 108 and attachment portion 110 are separate elements and not integrally formed, the attachment portion 110 may be rigidly or flexibly connected to the gripping portion 108. For example, the attachment portion 110 may be rigidly glued, adhered, or fastened or the attachment portion 110 may be flexibly hinged to the gripping portion 108. Where the attachment portion 110 is a strip or strap, the attachment portion 110 may be tied to or otherwise secured to the gripping portion 108 with a knot, hook and loop, adhesive, or other fastening system.

As shown in FIG. 2, the present handle 102 is in the shape of a ring. The gripping portion 108 is formed by a first portion of the ring and the attachment portion 110 is formed by the remaining portion of the ring. As shown, the attachment portion 110 may rigidly extend from each side of the gripping portion 108 and curve in a circular or other arcuate manner to form the remaining portion of the ring.

In FIG. 12, the attachment portion may include the clip side of the ring opposite the gripping portion 108. The two connecting ends of the carabiner clip may form a transition between the gripping portion 108 and the attachment portion 110. The attachment portion shown may include openable clip that is biased toward the closed position. That is a bar extending along the attachment portion may be hingedly connected to the body of the carabiner and may pivot into the internal space defined by the carabiner clip allowing one or more extension portions to be attached or removed from the handle 102.

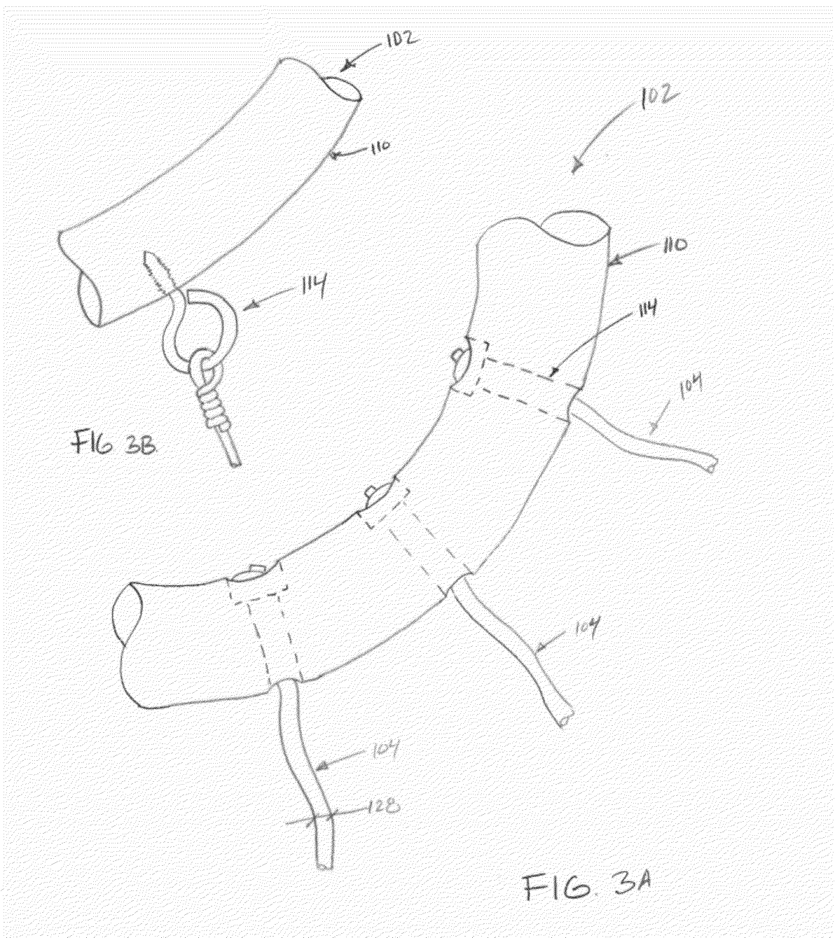

As shown in FIG. 3A, the attachment portion 110 may include connection features 114 for attachment of the extension elements 104. The connection features 114 may include perforations, as shown, rings, hooks, loops, threaded holes, threaded shafts, or other fastening elements for securing the extension elements 104 to the handle 102. Where perforations are provided, the extension elements 104 may extend therethrough and may be knotted to prevent parting of the extension elements 104 from the handle 102. In other embodiments, the extension elements 104 may extend through the perforation and wrap around the attachment portion 110 and be tied thereto. Where rings, hooks, or loops are provided, as shown in FIG. 3B, the extension elements 104 may be tied or otherwise secured to the hooks, rings, or loops. Where threaded holes or shafts are provided, the extension elements 104 may be provided with corresponding threaded shafts or nuts for engagement of the respective connection feature 114 on the attachment portion 110.

In some embodiments, connection features 114 may be omitted and the extension elements 104 may include clips 116 or other connection devices for surrounding, grasping, or otherwise engaging the attachment portion 110 of the handle 102. For example, as shown in FIG. 2, the extension elements 104 may include clips 116 configured for hooking around the attachment portion 110 and securing the extension elements 104 thereto. In still other embodiments, the extension elements 104 may be tied to the attachment portion 110. In this embodiment, the extension element may wrap around the attachment portion 110 and be secured to itself with a knot, swage sleeve, or other securing device. For example, as shown in FIG. 12, the extension element may loop around the attachment portion and loop back on itself. A swage sleeve or other rope fastening clip may be used to secure the free end to the rope thereby closing the loop and securing the extension element to the attachment portion of the handle.

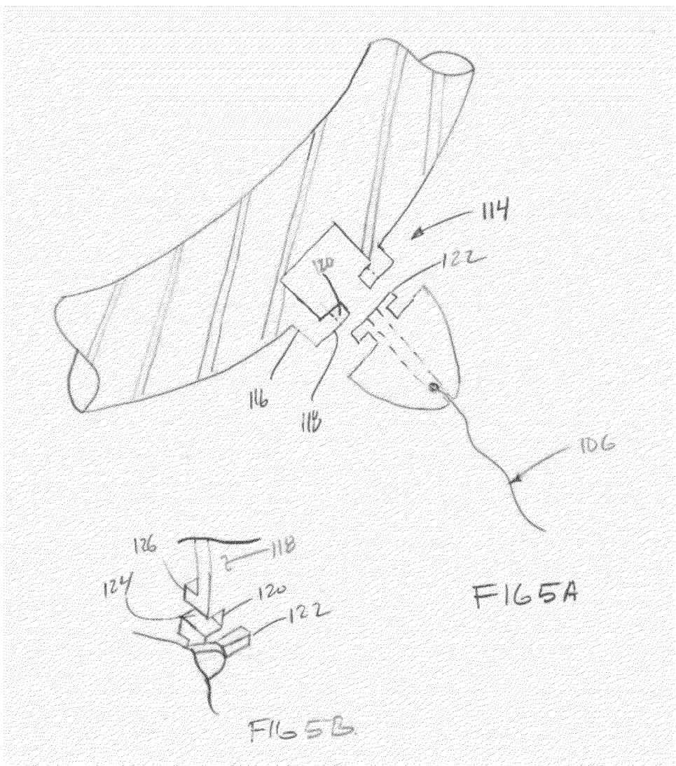

In one particular embodiment, as shown in FIG. 5A, the connection feature 114 may include an interlocking perforation or recess having a raised rim 116 and a collar 118. The collar 118 may include one or more slots 120 for receiving a tab 122 from a connection element on the extension element 104 or attraction element 106. The connection element may be pressed against the connection feature 114 causing the tab 122 to pass through the slot 120. The connection element may be twisted or turned to cause the tab 122 to pass behind the collar 118 securing the extension element 104 thereto. In some embodiments, as shown in FIG. 5B, the slot 120 may have an inward extending channel 124 with an inner edge 126 positioned inward from the inside surface of the collar 118. As such, the tab 122 may be passed into the slot 120 through the channel 124 and beyond the inward edge 126 of the channel 124. The connection element and tab 122 may then be turned or twisted outside the channel 124 and moved outward toward the inward surface of the collar 118. The connection element may be spring loaded or otherwise biased to cause the tab 122 to stay in contact with the inward surface of the collar 118 thereby being prevented from re-aligning with the slots 120 by the edge of the channels 124. Other connection features may be provided including with or without interlocking features for securing the extension elements thereto.

The handle 102 may be made from several materials or a single material may be used. For example, the handle 102 may be made from metal, wood, plastic, or rubber. Other materials may also be used. The handle 102 may be molded, extruded, carved, or otherwise formed from a raw material. The handle 102 may be a solid element or hollow element. Other shapes, sizes, materials and other aspects of handles or hubs 102 may be provided. In one embodiment, the handle may be an anodized aluminum handle, for example.

Turning now to the extension elements 104, an elongate element may be provided and configured to resisting tensile forces induced as a child and adult each hold on to their respective handle 102 and attraction elements 106. The extension element 104 may be a rigid or inflexible element or the extension element 104 may be flexible. Rigid elements 104 may include rods, sticks, or other relatively rigid elements. Flexible extension elements 104 may include string, rope, chain, chord or other flexible tension resisting elements. In some embodiments, the flexible extension element 104 may include a nylon, polyester, hemp, teflon, or cotton type rope or chord. Other materials and combinations of materials may also be used and tangle free braids, arrangements, or patterns may also be used. In still other embodiments, stretchable materials such as, for example, rubber or other elastomeric materials may also be used. In some embodiments, a lanyard type extension element may be used with rings, clips, or other connection features on each end.

The extension element 104 may be configured to connect the handle 102 and the attraction element 106 without parting under forces induced by child and parent tugging and the like. As shown in FIG. 3A, the extension element 104 may have a range of diameters 128 from approximately 1/64″ to approximately 1″. In other embodiments, the extension element diameter 128 may range from approximately 1/32″ to approximately ½″. In still other embodiments, the extension element diameter 128 may range from approximately ⅛″ to approximately ¼″. The diameter 128 of the extension element 104 may be maintained at a large enough size to minimize hazards to the user or the child if the extension element 104 were to tightly wrap around an extremity of the child or user. That is, for example, larger diameter 128 extension elements 104 may reduce potential injuries to wrists of the child or user where the extension element 104 gets wrapped around the wrist.

The extension element 104 may be attached to the attraction element 106 in a similar way as it connects to the attachment portion 110 of the hub or handle 102. That is, connection features 114 as previously described may be provided on the attraction element 106. For example, connection features 114 including perforations, rings, hooks, loops, threaded holes, threaded shafts, or other fastening elements for securing the extension elements 104 to the attraction element 106 may be provided. Where perforations are provided, the extension elements 104 may extend therethrough and may be knotted to prevent parting of the extension elements 104 from the attraction element 106. In other embodiments, the extension elements 104 may extend through the perforation and wrap around the attachment element 106 and be tied thereto. Where rings, hooks, or loops are provided, the extension elements 104 may be tied or otherwise secured to the hooks, rings, or loops. Where threaded holes or shafts are provided, the extension elements 104 may be provided with corresponding threaded shafts or nuts for engagement of the respective connection feature 114 on the attraction element 106. Loops in the extension element including knots, swage sleeves, or other rope clips, may also be provided for connecting to the attraction element 106.

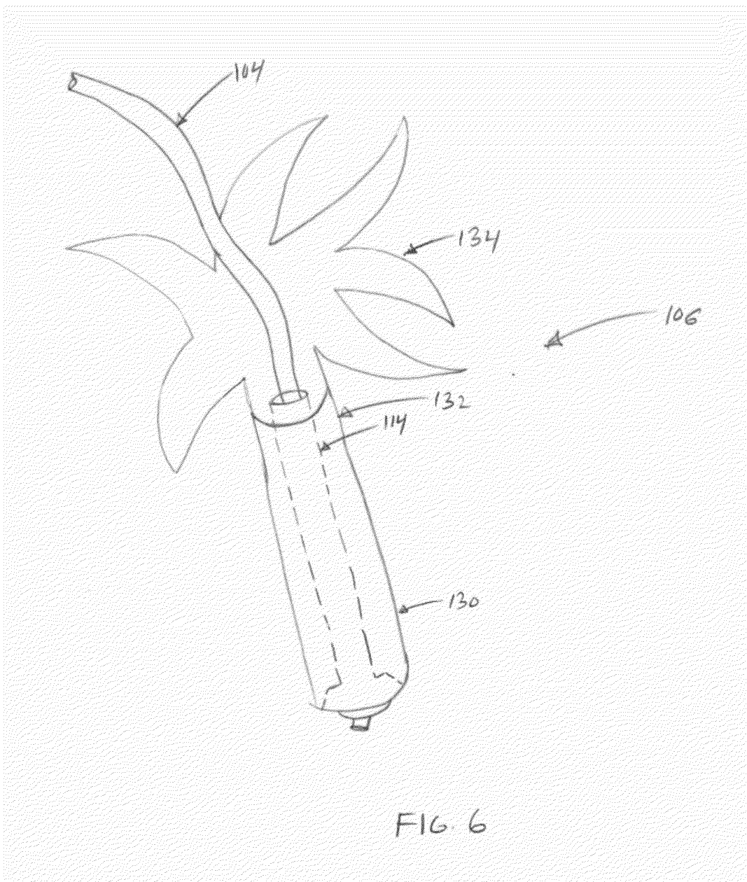

The attraction element 106 may be configured for engagement with a child and may also be configured to draw the child's attention to the element 106 and create a desire within the child to remain engaged with the attraction element 106. The attraction element 106 may be provided on the distal end of the extension element 104. In some embodiments, the attraction element 106 may be in the form of a strap, bracelet, or other element for engagement with a child's hand, wrist, torso, or other body part or it may have such a strap, bracelet or other engagement element extending therefrom as shown in FIG. 4. Again, like the hub or handle 102, the attraction element 106 may be adapted for surrounding a body part by being stretched and placed around the body part or wrapped and secured around the body part with a securing means. In other embodiments, as shown in FIG. 6, the attraction element 106 may include a gripping portion 130 and an attachment portion 132. The gripping portion 130 may be configured for gripping by the child. The gripping portion 130 of the attraction element 106 may have the same or similar features as the gripping portion 108 of the hub or handle 102. That is, it may be generally cylindrical and sized to accommodate a child's hand. Other cross-sectional shapes may also be provided. A rubber grip or sleeve may be provided or a textured or grooved surface may also be provided. The gripping portion 130 may also be straight, arcuate, or angular. In some embodiments, the gripping portion may be similar to a jump rope handle for example and may be a wood article shaped with a lathe, for example.

In addition to a gripping portion 130, the attraction element 106 may include an attachment portion 132 extending therefrom. The attachment portion 132 may, like the handle or hub 102, extend rigidly or flexibly from the gripping portion 130 and may be configured with connection features 114 for securing extension elements 104 thereto.

In addition to a gripping portion 130 and attachment portion 132, the attraction element 106 may have an attraction feature 134. The attraction feature 134 may extend from the attraction element 106 or it may be incorporated therein. For example, the attraction feature 134 may include a particular shape or symbol such as a star, circle, triangle, or other shape. In some embodiments, the attraction feature 134 may include facial features, designs, or other depictions for attracting a child's attention. In some embodiments, the attraction feature 134 may be an image or sculpture of a character from a cartoon, movie, book, or other media. The attraction feature 134 may be positioned on the attraction element 106 so as to be exposed to view to the child when the attraction element 106 is engaged with the child. As shown in FIG. 6, the attraction feature 134 may extend upward from the gripping portion 130.

The attraction feature 134 of the attraction element 106 may be incorporated into all or a portion thereof by, for example, providing the attraction element 106 in the form of a toy. For example, an airplane-shaped attraction element 106 may be provided where the gripping portion 130 comprises a portion of the body or shell of the plane. In other embodiments, for example, a dinosaur attraction element 106 may be provided where the gripping portion 130 comprises a portion of the body or torso portion of the dinosaur. Similarly, a dragon type attraction element 106 may be provided and the gripping portion 130 may comprise a portion of the tail, for example. In these embodiments, flappable wings, lights, propellers, or other working features of the toy may be incorporated into the attraction element 106 to further maintain the child's attention and desire to hold onto the attraction element 106. Other types of animals, dolls, characters, action figures, toys, model toys, or other toy-like elements may be incorporated into the attraction element 106.

The attraction element 106 may be made from several suitable materials. In some embodiments, the attraction element 106 may be made from a wood material and may be carved, cut, and sculpted and may be further painted or otherwise colored. In other embodiments, the attraction element 106 may be made from plastics, metals, alloys, or other common materials used to produce toys for children. The attraction element may be molded, extruded, cast, or otherwise formed from these materials.

In some embodiments, a retractability feature 136 may be provided to take-up slack in the extension element 104 and prevent tangling of more than one extension element 104. In these embodiments, the retractability feature 136 may be incorporated into the hub or handle 102. In other embodiments, the retractability feature 136 may be provided as part of the extension element 104. In still other embodiments, the retractability feature 136 may be incorporated into the attraction element 106.

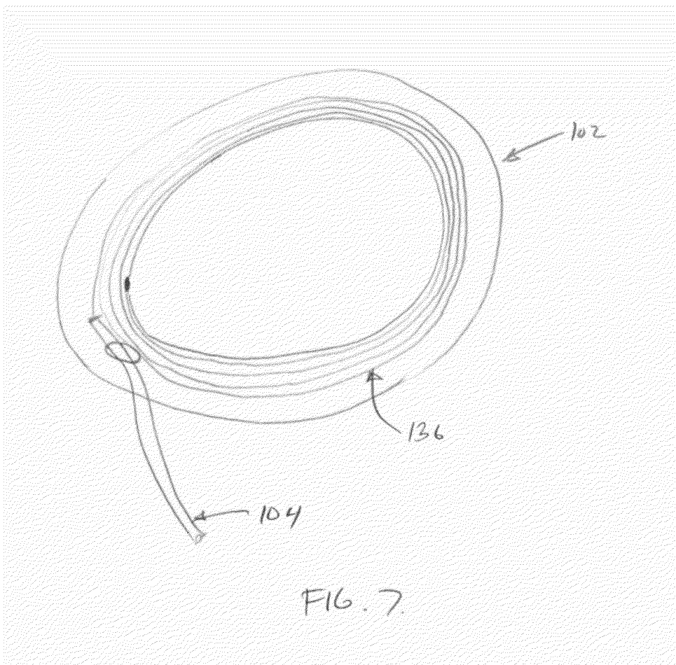

Referring now to FIG. 7, the retractability feature 136 may be incorporated into the hub or handle 102. In this embodiment, the extension element 104 may pass into or onto the hub or handle 102 and a take-up device such as a biased spool, spindle, or other take-up device may be provided. This may be similar to a tape measure, for example, and may be provided for each extension element 104 separately or collectively.

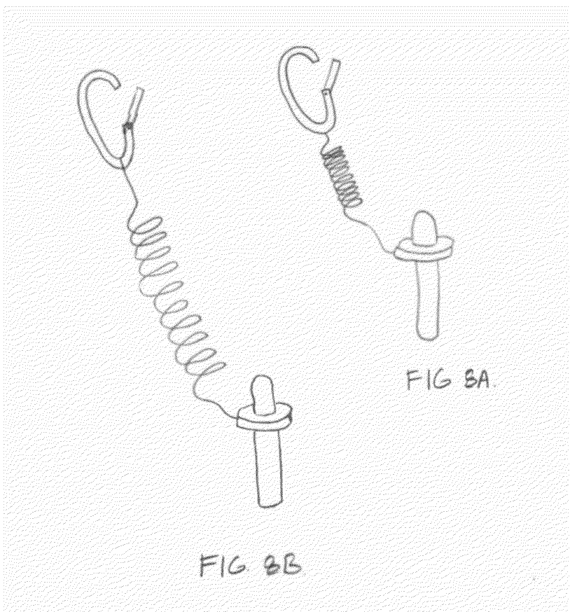

Referring again to FIG. 2, the retractability feature 136 may be incorpoarted into the extension element 104 by providing a canister or other take-up element as part of the extension element 104. As shown, the take-up canister may be connected to the hub or handle 102 and the extension element 104 may extend into the canister and may include a take-up device such as a biased spool, spindle, or other take-up device. In still other embodiments, as shown in FIGS. 8A and 8B, the retractability feature 136 incorporated into the extension elements 104 may include spiral or coil type extension elements that naturally uncoil or stretch (FIG. 8B) when tension is applied and naturally recoil (FIG. 8A) upon release of tension.

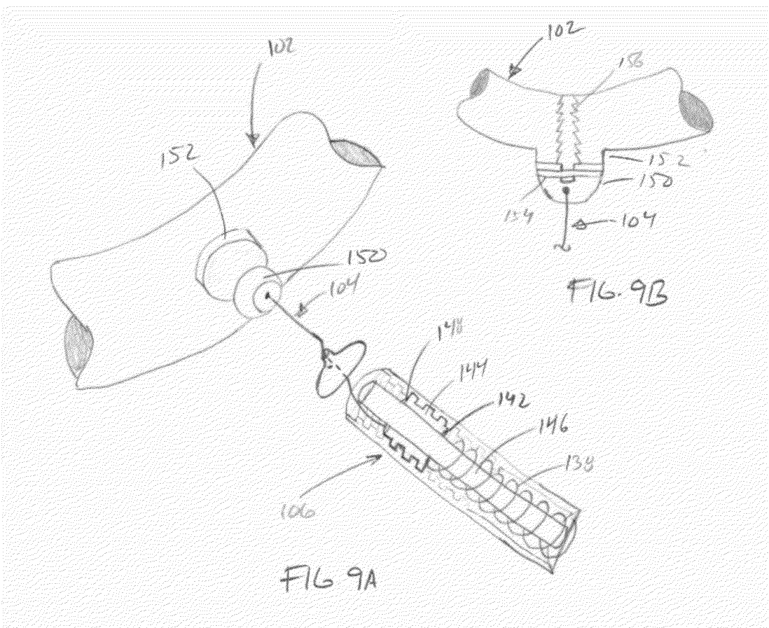

Referring now to FIGS. 9A and 9B, the retractability feature 136 may be incorporated into the attraction element 106. In this embodiment, the extension element 104 may pass into or onto the attraction element 106 and a take-up device such as a biased spool, spindle, or other take-up device may be provided. As such, when tension is applied to the extension element 104, the extension element 104 may uncoil or unroll and extend from the attraction element 106. When released, the extension element 104 may be drawn back into the attraction element 106 to take-up slack in the extension element 104.

With continued reference to FIGS. 9A and 9B, a biased spindle type device may be described. As shown, the device may include a spring 138 secured at one end to a substrate. For example, the spring 138 may be secured at one end to the hub or handle 102, or the canister, or the attraction element 106. The other end of the spring 138 may be secured to a biasing end 142 of a threaded piston 144 positioned in the substrate in a threaded shaft and surrounding a collection spindle 146. The threaded piston 144 may have another extension end 148 opposite the biasing end 142 and the extension element 104 may be attached thereto.

In a starting or unloaded condition, the spring 138 may be provided in a relatively tight or closed position drawing the threaded piston 142 to the bottom of its stroke near the bottom of the threaded shaft. The extension element 104 may be provided in a coiled position around the collection spindle 146. As such, when tension is applied to the extension element 104 it may be uncoiled by advancing the piston 144, thereby rotating the piston 144, and also stretching and rotating the spring 138. This may allow a portion of the extension element 104 to extend out of the attraction element 106, for example. As further tension is applied, the piston 144 may be furthered advanced and further stretch and rotation may be imparted on the spring 138 and the extension element 104 may further extend from the attraction element 106, for example. When tension is relieved from the extension element 104 by releasing the attraction element 106 or otherwise closing the distance between the hub or handle 102 and the attraction element 106, for example, the loaded spring 138 may pull on the piston 144, rotating the piston 144 and drawing the piston 144 back down its stroke while pulling the extension element 104 into the attraction element 106 and coiling the extension element 104 around the collection spindle 146. In some embodiments, the collection spindle 146 may be stationary relative to the rotating piston 144 and spring 138. In other embodiments, the spindle 146 may rotate therewith by being keyed thereto. That is, the spindle 146 may include a keyway groove extending the length of the spindle 146 and the piston 144 may include a key engaging the groove causing the spindle 146 to spin with the piston 144. The rotating spindle 146 may allow the extension element 104 to more freely wrap on the spindle 146 without constricting on the spindle 146 and causing it to hang up.

In other embodiments, the retractability feature 136 may include a lock preventing the extension element 104 from extending unless unlocked. For example, the retractability feature 136 may be incorporated into the attraction element 106 and, thus, the extension element 104 may be coiled therein and may include a plug 150 at an exposed end of the extension element 104. A locking feature may be built into the connection between the plug 150 and a socket 152, for example, on the hub or handle 102 and the locking feature may be related to the functionality of the retractability feature 136. The locking feature may be configured such that securing the plug 150 to the socket unlocks the lock and, in turn, frees the retractability feature 136 allowing the extension element 104 to extend from the attraction element 106. The locking feature may include a particular arrangement of tabs in the socket 152 on the hub or handle 102 configured to engage a particular arrangement of slots in the plug 150 portion of the extension element 104. The relationship between the lock and the retractability feature 136 may be in the form of a keeper block or stay preventing rotation or motion of the retractability feature 136 unless the lock is unlocked. Upon engaging the plug 150 with the socket 152, the locking feature may be released freeing the motion of the retractability feature 136 and allowing a portion of extension element 104 to be released from the attraction element 106 and allowing the attraction element 106 to extend away from the hub or handle 102. It is noted that the plug 150 may be the same or similar to the connection element described with respect to FIGS. 5A and 5B and the socket may be the same or similar of the connection feature 114 described with respect to FIGS. 5A and 5B also.

In this embodiment, several sockets 152 or other connection features 114 may be provided on the hub or handle 102 and the attraction element 106 may be interchangeable between several sockets 152 or connection features 114. As such, a consumer may choose the type of attraction element 106 desired and combine the attraction element 106 with the hub or handle 102 as desired. In some embodiments, the plug 150 and socket 152 may be adapted for interlocking engagement as show in FIG. 9B, where pin 154 may be removed laterally to free plug 150 from toothed shaft 156. subsequently, a new plug 150 may be secured to toothed shaft 156 or the shaft 156 may be advanced through the hub or handle 102 and removed.

In other embodiments, the attraction element 106 may be configured for holding or securing another object therein. For example, the attraction element 106 may include a spring loaded or biased grasping device or clamp. The clamp may be particularly adapted, for example, for grasping a stick of a sucker or other candy. In this embodiment, for example, the user may place a candy or other element in the clamping device for attraction of the child. In this embodiment, the grasping device may be in lieu of or in addition to an attraction feature 134.

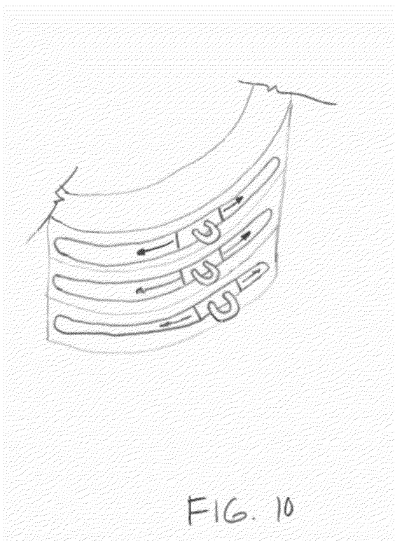

In still other embodiments, as shown in FIG. 10, a series of tangle free connection features 114 may be provided on the hub or handle 102. In this embodiment, each extension element 106 may be secured to independently moving connection features 114. As shown, the connection features 114 may individually slide in tracks on the hub or handle 102 allowing one connection feature 114 to pass by another connection feature 114. Accordingly, to extension elements 104, or more, may switch positions relative to the hub or handle 102 without getting tangled around each other since their point of contact with the hub or handle 102 may also switch.

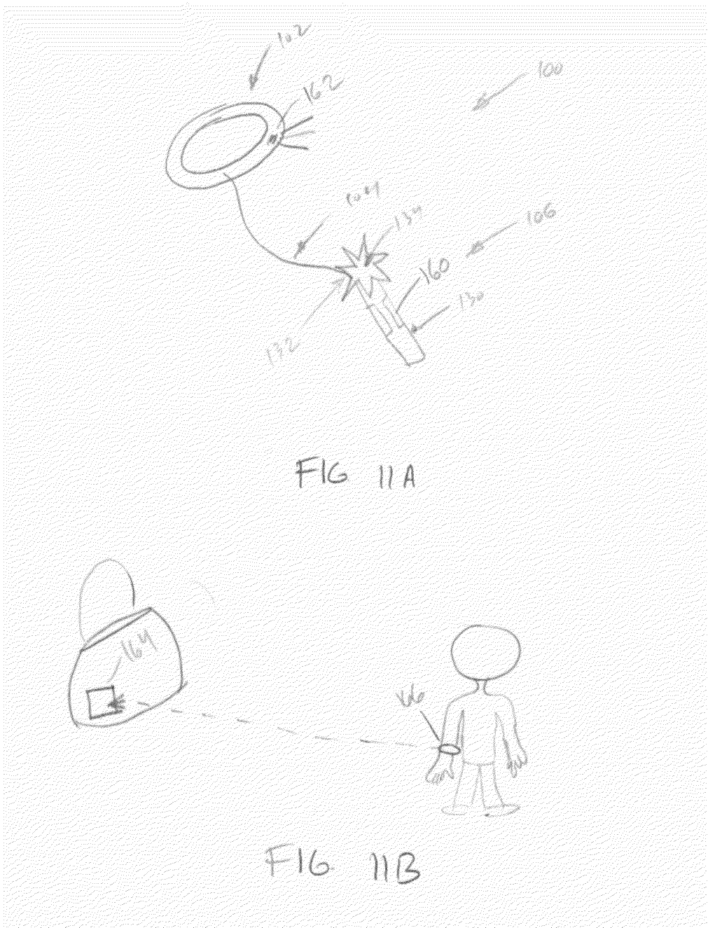

In still other embodiments, as shown in FIGS. 11A and 11B, the proximity device 100 may be equipped with a sensor. In these embodiments, for example as shown in FIG. 11A, the attraction element 106 may include touch sensors 160 positioned on the gripping portion 130 of the attraction element 106. The touch sensors 160, similar to those often found on exercise equipment may allow for the completion of a circuit when gripped by the child thereby bypassing an alarm signal. However, when the child lets go of the gripping portion, the touch sensors 160 may cause an open circuit triggering an alarm 162 on the hub or handle 102 allowing the caretaker to take immediate action to locate the child.

In the embodiment shown in FIG. 11A, the sensors and the alarm 162 may communicate via a wired connection or they communicate wirelessly. Where a wired connection is provided, a single power source may also be provided. That is, a power source may be positioned on or in the hub or handle or it may positioned on or in the attraction element or on or in the extension element or elements. The power source may power the circuit for the touch sensors 160 and may also power the alarm 162. When the circuit across the sensor is broken, for example, when a child lets go, the sensor circuit may transmit a signal to the alarm via the wired connection extending therebetween and the alarm may sound, vibrate, or otherwise notify the caretaker of a disengaged child. In this embodiment, the wired connection may pass within or along the extension elements thereby connecting the sensor circuit on the attraction element to the alram on the hub or handle.

Where a wireless connection is provided, the alarm 162 and the sensors 160 may each have separate power sources and may communicate via a transmitter and a receiver. In this embodiment, for example, where the sensor circuit is broken, the sensor circuit may trigger a transmitter to send a signal to the receiver of the alarm. The receiver may receive the signal and sound the alarm indicating to the caretaker that the child may not be holding the attraction element any longer.

In still other embodiments, as shown in FIG. 11B, the proximity device may include a sensor 164 configured for retention by a caretaker. For example, the sensor 164 may be placed in a purse, pocket, or other locatoin near or on a caretaker. The sensor may sense the distance between it and a attraction element or receiver 166 on the child. When the distance becomes too large, the sensor 164 may trigger an alarm positioned thereon so the caretaker may take immediate action to locate the child.

In this embodiment, the sensor 164 may include a power source and a distance sensing feature configured to sense the attraction element location and calculate a distance therebetween. The attraction element may also include a power source and may be transmit a continuous or intermittent signal for receiving by a receiver on the sensor 164. In these embodiments, the attraction element may also include touch sensors to be sure the child is still holding onto the attraction element, thereby avoiding the condition where the child sets the attraction element down near the caretaker and wanders off without knowledge by the caretaker.

In still other embodiments, the attraction element may be configured for communication with a cell phone. For example, the attraction element may configured with a sensor for sensing the distance between the attraction element and a token or other item able to be sensed by the attraction element. Where the distance between the attraction element and the token exceeds a safe distance, the attraction element may text the cell phone of a caretaker to notify them that the child has strayed too far away. In this embodiment, the caretaker may keep the token or other item able to be sensed in a purse, pocket, or otherwise on their person for properly monitoring the child.

In the above embodiments, the sensors and sensed items may be reversed or otherwise arranged for communication and monitoring of child locations. That is, for example, in the cell phone example, the token or other item able to be sensed may be positioned in the attraction element and the sensor may be positioned with the caretaker. The sensor may then transmit a signal to a cell phone when the child has strayed or let go of the attraction element. In this embodiment, the sensor may be physically connected to the cell phone or may transmit a signal thereto.

As shown in FIG. 12 and mentioned throughout the specification, another embodiment of a proximity device is shown. In this embodiment, the handle or hub 102 may include a carabiner clip sized for gripping by an adult human hand and may include a larger or jumbo sized carabiner clip. An extension element or elements 104 in the form of a rope or ropes may be secured to the carabiner clip by looping around the attachment or clip side 110 of the handle 102. The ropes may have loops formed on their handle end with swage sleeves for example and may be slipped over the pivotable clip when the carabiner is open and the secured to the handle 102 by closing the clip. The opposite end of the extension element may be secured to an attraction element 106 by being sleeved therethrough and knotted. The attraction element may be in the form of a handle having a character or other attraction feature 134 thereon.

In one embodiment a method of maintaining the proximity of a child is provided. For example, the a user may grip a handle 102 and may encourage or hand one or more attraction elements to respective children. The user may guide the child or children through a parking lot and/or through a store, building, school, or other facility using the proximity device. The user may encourage the children to continue to hold onto their respective attraction elements and thus maintain their proximity to the user. Should one or more of the children let go of their respective attraction element, the user may sense such activity by the reduced tension on the device, hearing the attraction element fall, or feeling the attraction element swing against them. The user may then attend to regaining control or proximity to the child that has let go. The attraction elements and the attraction features may be selected, personalized, or otherwise tailored such that the child or children takes to the attraction element, desires their own attraction element, and dutifully holds onto the attraction element.

In some embodiments, the device may be used over a time while teaching the children the importance of maintaining their proximity to the user such as a parent, guardian, or other caretaker. This may be conducted with or without actual physical control due to the child's ability to decide whether to hang on or let go. In some embodiments, grades of control by the caretaker may be implemented. For example, the user may begin use of the device with a wrist strap on the child. As the child grows and learns to stay close, the wrist strap may be removed allowing the child more decisional control over their conduct. Once the child grows still older and further learns the importance of staying close, the caretaker may allow the child to walk along without use of the proximity device.

As best shown in FIGS. 1 and 2, the disclosed proximity device 100 may be advantageous due to the ability to maintain one or more children in the same or similar proximity to the caretaker. That is, as shown, the extension elements 104 may extend substantially radially from the caretaker and as such, each attraction element 106 and thus engaged child may remain similar distances from the caretaker. This may be particularly advantageous where the children engaged with the device are similar in age or are in need of similar levels of attention. When compared to several children in line or holding onto differing portions of a rope, for example, each child in the present disclosure may be maintained close to the caretaker avoiding having one or more children straying near the end of a line or rope, for example, and being at a higher risk for wandering off, or getting lost.

In one embodiment, a proximity device for a child may be provided. The device may include a hub configured for engagement with a caretaker, an extension element connected to the hub at a first end and extending to a second end, and an attraction element connected to the second end of the extension element. The attraction element may be configured for engagement with a child and may include an attraction feature desirable by a child. When the hub is engaged with a caretaker and the attraction element is engaged with a child, the device may control the proximity of the child to the adult.

In some embodiments, a retractability feature may be provided that is configured to take-up and release the extension element in response to tension applied thereto. In some embodiments, the retractability feature may be incorporated into the hub. In other embodiments, the retractability feature may be incorporated into the extension element. In still other embodiments, the retractability feature may be incorporated into the attraction element. In some embodiments, the retractability feature may be housed in a substrate in the form of one of the hub, a canister, and the attraction element. In some embodiments, the retractability feature may include a spindle arranged in the substrate, a biasing spring surrounding the spindle and having a first end secured to the substrate and a second end, and a threaded piston surrounding the spindle and having an inner side secured to the second end of the spring and an outer side. The extension element may extend into the substrate and may be secured to the outer side of the threaded piston. The extension element may be arranged in a coiled position when the extension element is untensioned and may uncoil when the extension element is tensioned. The spindle may be pivotable in the substrate and the threaded piston may be keyed to the spindle causing the spindle to rotate with the piston. The spindle may include a key way groove and the threaded piston may include a key configured for engaging the groove.

In some embodiments, the attachment portion of the hub may include a socket for engagement by a plug. In this embodiment, the extension element may include a plug configured for engaging the socket. In some embodiments, a retractability feature may be provided and may include a lock and engaging the plug with the socket may unlock the lock. In some embodiments, the lock may include a set of tabs positioned on the plug and a corresponding set of slots positioned on the plug.

In some embodiments, the attraction element may include a clamp configured for securing another element therein. In some embodiments, the another element may be a piece of candy. In still other embodiments, the piece of candy may be a sucker and the clamp may be adapted for securing the stick portion of the sucker to the attraction element.

In some embodiments, an interchangeable attraction element for the system may be provided. The attraction element may include an attraction feature desirable by a child and the attraction element may be configured for engagement with a child. When the hub of the system is engaged with a caretaker and the attraction element is engaged with a child, the device may control the proximity of the child to the adult. In some embodiments, the attraction element may include an extension element incorporated therein. In some embodiments, the attraction element may include a lockable retractability feature unlockable when engaged with the hub or handle. The attraction element may include a plug positioned on a first end of the extension element and the hub may include a socket for receiving the plug and unlocking the lock.

In some embodiments, the attraction element may include a sensor for determining whether a child is holding the attraction element. The hub may include an alarm configured to be set off when the child lets go of the attraction element. In other embodiments, the sensor may be proximity sensor and the device may be wireless and the proximity of the attraction element to the hub may be constantly or intermittently measured to determine the proximity of the attraction element and the child. An alarm may sound when the distance exceeds a selected limit.

In the foregoing description various embodiments of the present disclosure have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A proximity device for a child, comprising:
a hub configured for engagement with a caretaker;
an extension element connected to the hub at a first end and extending to a second end; and
an attraction element connected to the second end of the extension element, the attraction element being configured for engagement with a child and including an attraction feature desirable by a child,
wherein, when the hub is engaged with a caretaker and the attraction element is engaged with a child, the device controls the proximity of the child to the adult.

2. The device of claim 1, wherein the hub includes a gripping portion and an attachment portion.

3. The device of claim 1, wherein the extension element is removably connected to the hub.

4. The device of claim 3, wherein the hub includes an openable clip providing for the removably connected arrangement.

5. The device of claim 4, wherein the hub is a carabiner clip.

6. The device of claim 4, wherein the extension element includes a loop at a first end for connection to the hub.

7. The device of claim 6, wherein the loop is secured with a swage sleeve.

8. The device of claim 1, wherein the attraction element includes a handle and the attraction feature includes a depiction of an animal head.

9. The device of claim 1, wherein the extension element includes a plurality of extension elements each having respective first ends connected to the hub and radially extending from the hub and having an attraction element secured to respective second ends thereof, the respective attraction elements each having generally similar proximity limits on respective allowable radial distances from the hub.

10. The device of claim 1, wherein the attraction element is connected to the extension element by a sleevingly engaged and knotted connection.

11. The device of claim 1, further comprising a wrist strap for coupling a child's wrist to the extension element.

12. The device of claim 11, wherein the wrist strap includes a clip for securing directly to the extension element and a loop for extending around the child's wrist.

13. The device of claim 12, wherein the wrist strap further comprises an adjustment feature for cinching the strap on the child's wrist.

14. The device of claim 1, wherein the hub includes a wrist band securable to the caretaker.

15. A method of maintaining a child in close proximity to a caretaker, comprising:
grasping a hub of a proximity device, the device including a hub configured for engagement with a caretaker, an extension element connected to the hub at a first end and extending to a second end, and an attraction element connected to the second end of the extension element, the attraction element being configured for engagement with the child and including an attraction feature desirable by the child;
encouraging the child to grasp the attraction element;
confirming that the child has grasped the attraction element and is holding onto the attraction element;
guiding the child and maintaining the child in close proximity to the caretaker with the proximity device;
intermittently monitoring the child to confirm that the child continues to hold onto the attraction element.

16. The method of claim 15, wherein the proximity device includes a plurality of attraction elements, the method further comprising asking the child which attraction element the child desires to hold onto.

17. The method of claim 15, wherein the proximity device further comprises a wrist strap for the child, the method further comprising securing the wrist strap to a wrist of the child.

18. The method of claim 17, wherein the proximity device includes a plurality of extension elements and the wrist strap is coupled to one of the extension elements and securing the wrist strap further comprises identifying a youngest child of a plurality of children and securing the wrist strap to the youngest child.

19. The method of claim 18, wherein encouraging the child to grasp the attraction element includes encouraging the plurality of children to grasp the attraction elements.

20. The method of claim 15, wherein the proximity device further comprises a wrist strap for securing the proximity device to the caretaker, the method further comprising using both hands to conduct a task with the proximity device secured to a wrist.
